(19) United States
(12) Patent Application Publication
(10) Pub. No.: US 2017/0051899 A1
(43) Pub. Date: Feb. 23, 2017

(54) METHODS AND APPARATUS FOR SUPPORTING A LAMP

(71) Applicant: Vanderlei Rainelli Ferreira, Sao Paulo (BR)

(72) Inventor: Vanderlei Rainelli Ferreira, Sao Paulo (BR)

(21) Appl. No.: 14/982,402

(22) Filed: Dec. 29, 2015

(30) Foreign Application Priority Data
Aug. 18, 2015 (BR) BR1020150198337

(51) Int. Cl. F21V 21/00; F21V 23/06

(52) U.S. Cl. CPC F21V 21/00; F21V 23/06

(57) ABSTRACT

An apparatus for supporting a lamp is described. The apparatus includes a top plate for mounting to a structure. The top plate includes at least one protrusion. A housing includes at least one slot for accepting the at least one protrusion such that the housing and the top plate are capable of being removably coupled together. A socket is positioned at least partially within the housing and adapted to provide electrical current to the lamp when the lamp is connected to the socket.

### TECHNICAL FIELD

This invention relates to the installation and support of electrical lamps, such as tubular-shaped lamps.

### BACKGROUND OF THE INVENTION

It is known to install lamps using complex fixtures having many parts and mounting hardware. Installing these complex fixtures requires substantial labor and expense. Additionally, manufacturers generally include extra mounting hardware in installation kits due to installers inevitably dropping and losing hardware while installing lighting fixtures, especially when standing on ladders during installation. This can lead to added expense and waste.

### SUMMARY

In one aspect, the invention is embodied in an apparatus for supporting a lamp. The apparatus includes a top plate for mounting to a structure. The top plate includes at least one protrusion. A housing includes at least one slot for accepting the at least one protrusion such that the housing and the top plate are capable of being removably coupled together. A socket is positioned at least partially within the housing and adapted to provide electrical current to the lamp when the lamp is connected to the socket.

In alternate embodiments, the lamp can be a florescent lamp, light emitting diode (LED) lamp, or a halogen lamp. The structure can be an electrical channel, a ceiling or a wall. The apparatus can include an adapter for mounting the top plate to the electrical channel. In one embodiment, the electrical channel is a wiremold raceway system.

In one embodiment, an interior portion of the housing includes a U-shaped channel for supporting the electrical socket. The socket can be a G13, G5, R17D, T8, T10 or T12 socket. The top plate can be configured to support multiple housings. The top plate can be mounted to the structure using a screw, a nail, a staple, glue, a latch and/or a hook. The protrusion on the top plate can include a latch located on a distal end of the protrusion.

In another aspect, the invention is embodied in an apparatus for supporting a lamp. The apparatus includes an adapter having a first latch for mounting the adapter to an electrical channel. A top plate includes a first slot for accepting the first latch such that the adapter and the top plate are capable of being removably coupled together. The top plate includes a second protrusion. A housing includes a slot for accepting the second protrusion such that the housing and the top plate are capable of being removably coupled together. A socket is positioned at least partially within the housing and adapted to provide electrical current to the lamp when the lamp is connected to the socket.

The apparatus can also include a cover for at least partially covering the adapter. In alternate embodiments, the lamp can be a florescent lamp, light emitting diode (LED) lamp, or a halogen lamp. In one embodiment, the electrical channel is a wiremold raceway system. The socket can be a G13, G5, R17D, T8, T10 or T12 socket. In one embodiment, an interior portion of the housing includes a U-shaped channel for supporting the electrical socket. The top plate can be configured to support multiple housings.

In another aspect, the invention is embodied in a method for installing a lamp. The method includes mounting a top plate to a structure. The top plate includes at least one protrusion. The method further includes positioning a socket at least partially within a housing. The housing is removably coupled to the top plate by inserting the at least one protrusion into at least one slot in the housing. The lamp is connected to the socket.

In alternate embodiments, the structure includes an electrical channel, a ceiling or a wall. The method can also include mounting the top plate to the electrical channel.

### BRIEF DESCRIPTION OF THE DRAWINGS

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

The above and further advantages of this invention may be better understood by referring to the following description in conjunction with the accompanying drawings, in which like numerals indicate like structural elements and features in various figures. Skilled artisans will appreciate that reference designators shown herein in parenthesis indicate components shown in a figure other than the one in discussion. For example, talking about a device (10) while discussing Figure A would refer to an element, 10, shown in figure other than Figure A.

FIG. 1 is a top perspective view of a top plate according to the invention;

FIG. 2 is a bottom perspective view of an alternative top plate according to the invention;

FIG. 3 is a bottom perspective view of alternative top plate according to the invention;

FIG. 4 is a perspective view of an adapter for mounting a top plate to an electrical channel according to the invention;

FIG. 5 is a side view of the adapter of FIG. 4 according to the invention;

FIG. 6 is a perspective view of a housing according to the invention;

FIG. 7 is a side view of the housing of FIG. 6 according to the invention;

FIG. 8 is a perspective view of a cover for covering the adapter of FIG. 4 according to the invention;

FIG. 9 is an exploded view of an assembly for supporting a single lamp according to the invention;

FIG. 10 is a perspective view of a completed assembly including a single lamp according to the invention.

FIG. 11 is an exploded view of another assembly for supporting a pair of lamps according to the invention;

FIG. 12 is an exploded view of yet another assembly for supporting four lamps according to the invention;

FIG. 13A illustrates the assembly of FIG. 9 in an assembled state according to the invention;

FIG. 13B illustrates the assembly of FIG. 11 in an assembled state according to the invention; and

FIG. 13C illustrates the assembly of FIG. 12 in an assembled state according to the invention.

### DESCRIPTION OF PREFERRED EMBODIMENTS

The following detailed description is merely illustrative in nature and is not intended to limit the invention or the application and uses of the invention. Furthermore, there is no intention to be bound by any express or implied theory presented in the preceding technical field, background, brief summary or the following detailed description. For the purposes of conciseness, many conventional techniques and principles related to the installation of conventional light fixtures, need not, and are not, described in detail herein.

Techniques and technologies may be described herein in terms of functional components and various processing steps. It should be appreciated that such components may be realized by any number of hardware components configured to perform the specified functions.

The following description may refer to elements or features being “connected” or “coupled” together. As used herein, unless expressly stated otherwise, “connected” means that one element/feature is directly joined to (or directly communicates with) another element/feature. Likewise, unless expressly stated otherwise, “coupled” means that one element/feature is directly or indirectly joined to (or directly or indirectly communicates with) another element/feature. The term “exemplary” is used in the sense of “example, instance, or illustration” rather than “model,” or “deserving imitation.”

Technologies and concepts discussed herein relate to installation and support of electrical lamps. In an exemplary embodiment, an apparatus for supporting a lamp includes a top plate for mounting to a structure. The top plate includes at least one protrusion. The apparatus also includes a housing including at least one slot for accepting the at least one protrusion such that the housing and the top plate are capable of being removably coupled together. A socket is positioned at least partially within the housing and adapted to provide electrical current to the lamp when the lamp is connected to the socket.

One embodiment of the invention provides a practical and quick installation, mounting and support for tubular fluorescent lamps, LEDs tubular lamps or other similar lighting technologies for various surfaces (walls, slabs, woods, linings, rods, metallic structures, etc.) and for various installations, such as electrical channels.

The invention provides for more efficient installation of tubular lamps compared with other solutions on the market. For example, in the case of installing cable trays, embodiments of the invention use less hardware, such as mounting screws, thereby greatly reducing the number of components required. Additionally, by simplifying and streamlining the installation process, less waste is generated and installation costs are reduced.

In one embodiment, the invention is embodied in an assembly including several components. The components are coupled together by the application of pressure against corresponding mating surfaces. In the case of attachment to an electrical channel, an adapter having hooks, barbs, or latches is attached to the channel and a top plate is attached to the adapter. The choice of the top plate depends on the number and type of tubular lamps to be installed. For example, different top plates can support different numbers of lamps.

In the case of installing assemblies or sets of lamps on surfaces such as ceilings, walls, wood, metallic structures, or electrical channels, one embodiment of the invention incorporates a specific adapter for each purpose. Each different top plate includes one or more mounting holes for facilitating the installation process, assembly and locking the components together. In one embodiment, the invention is embodied in an assembly that provides ease of installation as well as improved security that provides a deterrent to theft of the lamps.

The assembly includes several modular components that can be removably coupled to each other. For example, the top plate can be attached to various surfaces, such as a ceiling, a roof, a walls, wood, linings, rods, metallic structures, cable trays or electrical channels. A housing is coupled to the top plate. The housing contains an electrical socket for receiving the lamp. The housing also allows for the use of various types of existing lamp sockets in the market, thus facilitating the installation of many types of tubular lamps regardless of the socket type that is used.

The top plate can be substantially rectangular in shape. However, any suitable shape can be used. The top plate can include one or more mounting holes. In one embodiment, the mounting holes are oblong to allow the position of the top plate to be adjusted. The top plate can also include one or more protrusions. Each protrusion can include a latch on a distal end. The latch can be used to removably secure a housing to the top plate. The top plate is also shaped to provide space for wires and an electrical socket. In one embodiment, one or more of the side walls of the top plate can include breakaway portions to allow an installer to have more flexibility during installation of the assembly. In one embodiment, the top plate is adapted to mount to a electrical channel, such as a wiremold raceway system using an adapter that removably couples the top plate to the electrical channel.

A socket is positioned inside a housing that removably couples to the top plate. In one embodiment, the housing contains a “U” shaped pocket for supporting the socket. The pocket can be any suitable shape for supporting the socket. In one embodiment, the housing includes a “T” shaped opening in the top to accommodate positioning the socket in the housing. In practice, the opening in the top of the housing can be any suitable shape.

The assembly can be installed using the following techniques. In the case of installation on surfaces such as ceiling tiles, ceilings and similar surfaces, the top plate is positioned by aligning the mounting holes in the top plate at the desired mounting location and attaching one or more screws to the mounting surface through the holes. Next, the electrical socket is placed in the housing and the wires are appropriately routed through the top of the housing. The housing is then mated to the previously mounted top plate. In one embodiment, the housing includes slots for receiving the protrusions of the top plate. The latches on the end of the protrusions catch in the slots on the housing, thereby securing the housing to the top plate. A lamp is then coupled to the socket in the housing.

In the case of installation in an electrical channel, such as a wiremold raceway system, the top plate is mounted to a U-shaped adapter that is removably coupled to the channel. In one embodiment, the U-shaped adapter includes latches that snap over the electrical channel to secure the adapter to the channel. The housing including the socket is then removably coupled to the top plate. A suitable lamp is coupled to the socket in the housing.

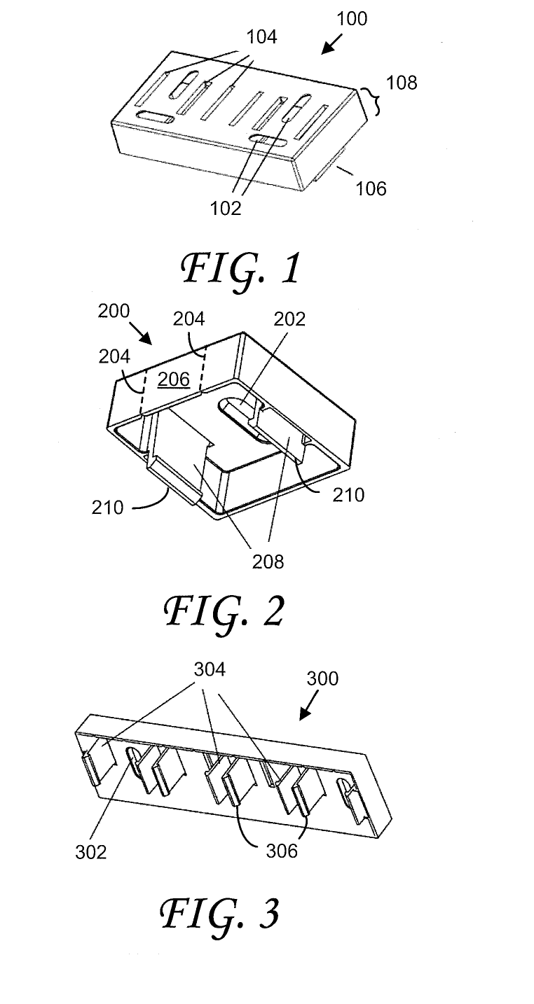

FIG. 1 is a top perspective view of a top plate 100 according to one embodiment of the invention. The tope plate 100 is configured to support two lamps (not shown). The top plate 100 includes one or more mounting holes 102 for mounting the top plate 100 to a structure (not shown), such as a ceiling, wall, electrical channel, rafter, girder, beam, strut, joist, or other suitable support. The mounting holes 102 can be oblong in shape to allow the position of the top plate 100 to be adjusted. Any suitable mounting technique can be used, such as using hardware (e.g., screws, bolts, nuts, etc.), hook and loop, glue, or tape, for example.

The top plate 100 also includes slots 104 for accepting protrusions from an adapter (not shown). The adapter is configured to mount the top plate 100 to an electrical channel (not shown). Skilled artisans will appreciate that other attachment techniques could also be used.

The top plate 100 also includes at least one protrusion 106 for removably coupling a housing (not shown) to the top plate 100. The protrusion 106 can include a latch (not shown) located on a distal end. In practice, the protrusion 106 can include any suitable feature positioned on the distal end, such as a claw, for example. The latch on the protrusion 106 is configured to “snap” into a corresponding slot in a housing (not shown).

The top plate 100 is illustrated as having a rectangular shape and having a certain thickness 108. However, the top plate 100 can be any suitable shape. The top plate 100 is generally designed to have a thickness which provides suitable strength and minimizes flex under a load.

FIG. 2 is a bottom perspective view of an alternative top plate 200 according to the invention. In this embodiment, the top plate 200 is configured to support a single lamp (not shown). The top plate 200 includes one or more mounting holes 202 for mounting the top plate 200 to a structure (not shown). The mounting holes 202 can be oblong in shape to allow the position of the top plate 200 to be adjusted.

The top plate 200 can optionally include break points 204 for allowing the removal of a portion of a wall 206. In one embodiment, an installer can route electrical wires or a cable though the removed portion of the wall 206 to facilitate installation of the assembly. Skilled artisans will appreciate that other wire routing techniques could also be used.

The top plate 200 also includes two protrusions 208 for removably coupling a housing (not shown). The protrusions 208 can include latches 210 located on the distal ends of the protrusions. In practice, the protrusions 208 can include any suitable feature positioned on the distal end, such as a barb, for example. Each latch 210 is configured to catch the back surface of a slot in the housing. In one embodiment, each latch 210 is shaped to securely hold the housing to the top plate 200, while permitting the top plate 200 and the housing to be separated under sufficient load. This removable coupling helps to facilitate installation of the assembly.

FIG. 3 is a bottom perspective view of alternative top plate 300 according to the invention. In this embodiment, the top plate 300 is configured to support four lamps (not shown). The top plate 300 includes one or more mounting holes 302 for mounting the top plate 300 to a structure (not shown). The mounting holes 302 can be oblong in shape to allow the position of the top plate 300 to be adjusted.

The top plate 300 also includes eight protrusions 304 for removably coupling four housings (not shown). In practice, any number of protrusions 304 can be used. The protrusions 304 can include latches 306 located on the distal ends of the protrusions. In practice, the protrusions 304 can include any suitable feature positioned on the distal end, such as a claw, for example.

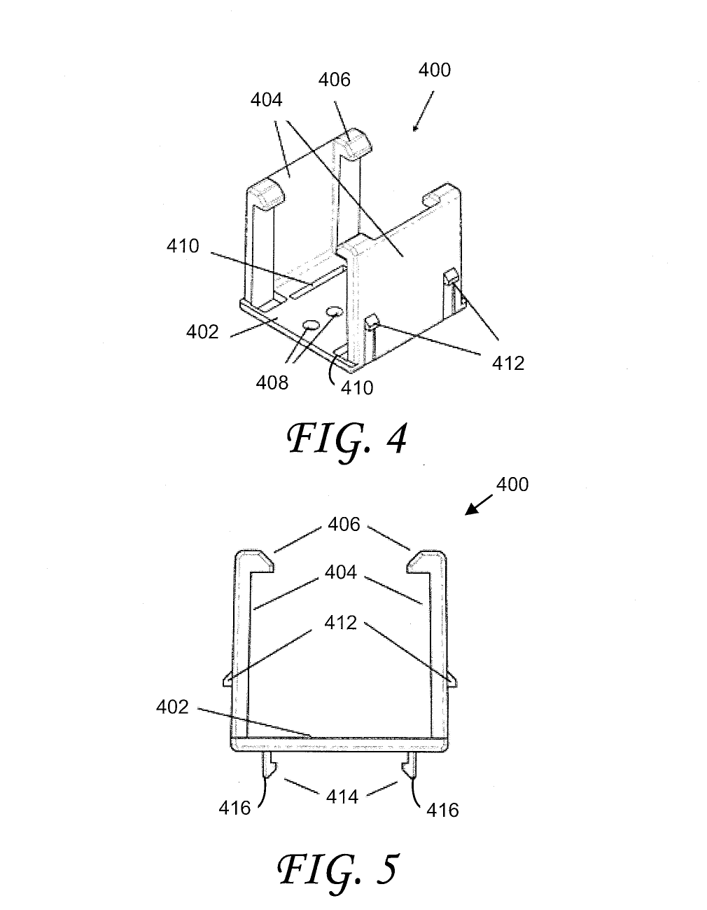

FIG. 4 is a perspective view of an adapter 400 for mounting a top plate to an electrical channel according to the invention. In one embodiment, the adapter 400 is substantially U-shaped. In practice, the adapter 400 can be any suitable shape. The adapter 400 includes a lower plate 402 and two side walls 404. The side walls 404 can include latches 406. The latches 406 are configured to grab the top of an electrical channel (not shown) to removably couple the adapter 400 to the channel. By removably coupled, we mean that the adapter can be securely coupled to the channel during installation, but can be removed without undue effort or damage to the adapter 400 or the channel.

The adapter 400 also includes one or more mounting holes 408. The mounting holes 408 can align with mounting holes 202 (FIG. 2) in the top plate 200. Similarly, the mounting holes 408 can align with mounting holes 302 (FIG. 3) in a different top plate 300.

The adapter 400 can also include slots 410. The slots 410 permit cables or wires to be routed from the electrical channel through the top plate 200, 300 into the housing (not shown). The adapter 400 also includes one or more smaller latches 412 which are provided to secure a cover (not shown) over the adapter 400.

FIG. 5 is a side view of the adapter 400 of FIG. 4 according to the invention. In this embodiment, the adapter 400 is substantially U-shaped. The adapter 400 includes the lower plate 402 and two side walls 404. The side walls 404 include the latches 406. The latches 406 are configured to grab the top of an electrical channel (not shown) to removably couple the adapter 400 to the channel. The adapter 400 also includes the smaller latches 412 which are provided to secure a cover (not shown) over the adapter 400.

In one embodiment, the adapter 400 includes protrusions 414. The protrusions 414 are adapted to engage with slots 104 (FIG. 1) in the top plate 100 to facilitate removably coupling the adapter 400 to the top plate 100. In one embodiment, the protrusions 414 include latches 416 configured to grab the underside of the slots 104 in the top plate 100 when the adapter 400 and the top plate 100 are coupled together.

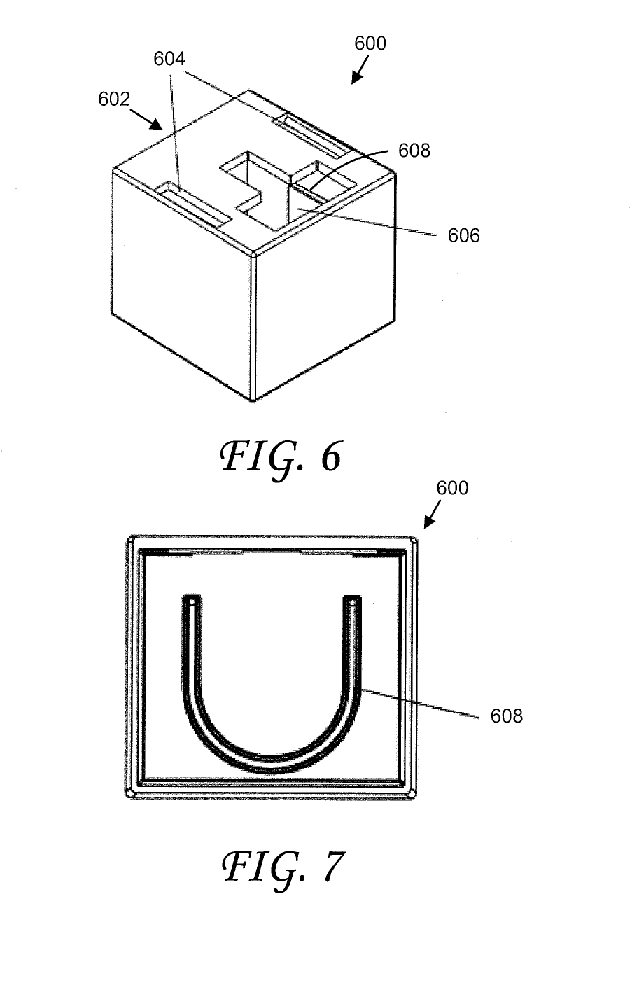

FIG. 6 is a perspective view of a housing 600 according to the invention. In one embodiment, the shape of the housing 600 is substantially rectangular. In practice, the housing 600 can be any suitable shape. One side 602 of the housing 600 does not include a wall, but instead is open. The housing 600 is adapted to support an electrical socket (not shown) for a lamp (not shown). The housing 600 can include slots 604. The slots 604 are adapted to receive the protrusions 208 (FIG. 2) from the top plate 200.

The housing 600 also includes an opening 606. In one embodiment, the opening 606 is T-shaped. The opening 606 is adapted to accept an electrical socket (not shown). A support 608 having a U-shape is formed within the housing 600. The support 608 is adapted to support the electrical socket. In practice, the support 608 can be any suitable shape.

FIG. 7 is a side view of the housing 600 of FIG. 6 according to the invention. The U-shaped support 608 is adapted to support an electrical socket (not shown). The electrical socket can be one of a G13, G5, R17D, T8, T10 or T12 electrical socket. Other suitable electrical sockets could also be used.

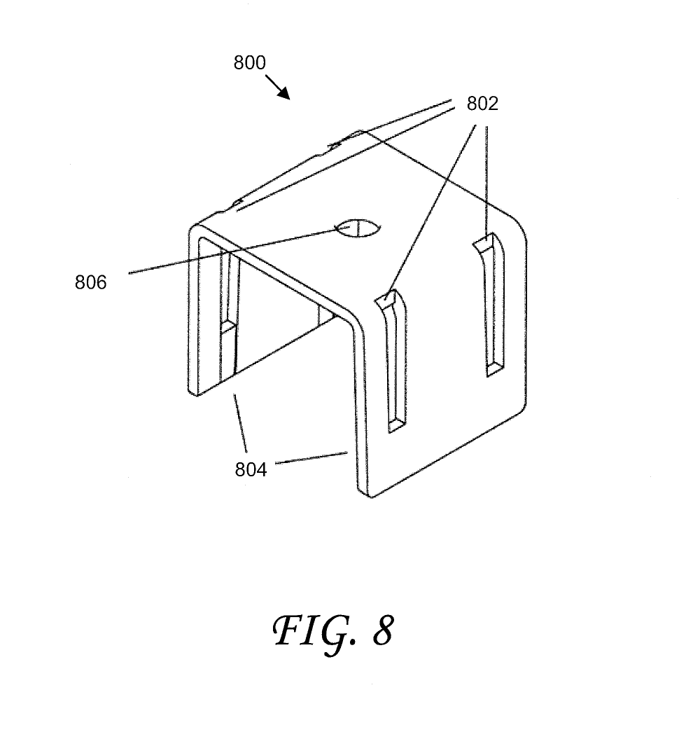

FIG. 8 is a perspective view of a cover 800 for covering the adapter 400 of FIG. 4 according to the invention. The cover 800 is substantially U-shaped, but any suitable shape could be used. In one embodiment, the cover 800 includes grooves 802 in the side walls 804. The grooves 802 are adapted to engage with the latches 412 on the adapter 400 when the cover 800 is positioned over the adapter 400.

The cover 800 can optionally include a mounting hole 806. The mounting hole can be adapted to accept a screw (not shown) or other mounting hardware. The mounting hole 806 can optionally be slotted.

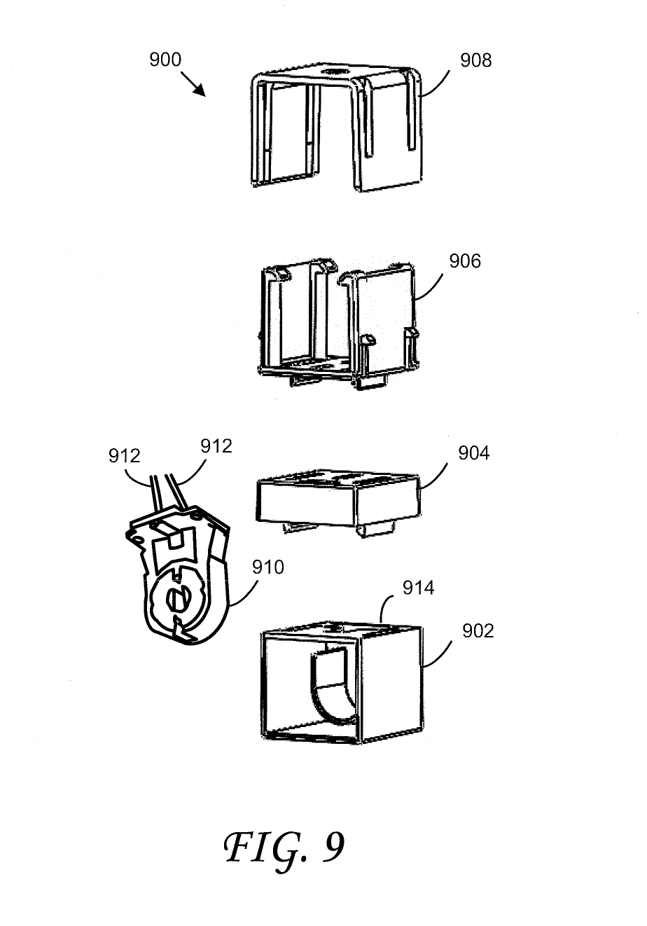

FIG. 9 is an exploded view of an assembly 900 for supporting a single lamp according to the invention. The assembly 900 includes a housing 902, a top plate 904, an adapter 906, and a cover 908. A socket 910 is positioned within the housing 902. In one embodiment, wires 912 from the socket 910 are routed though the top 914 of the housing 902 and through the top plate 904.

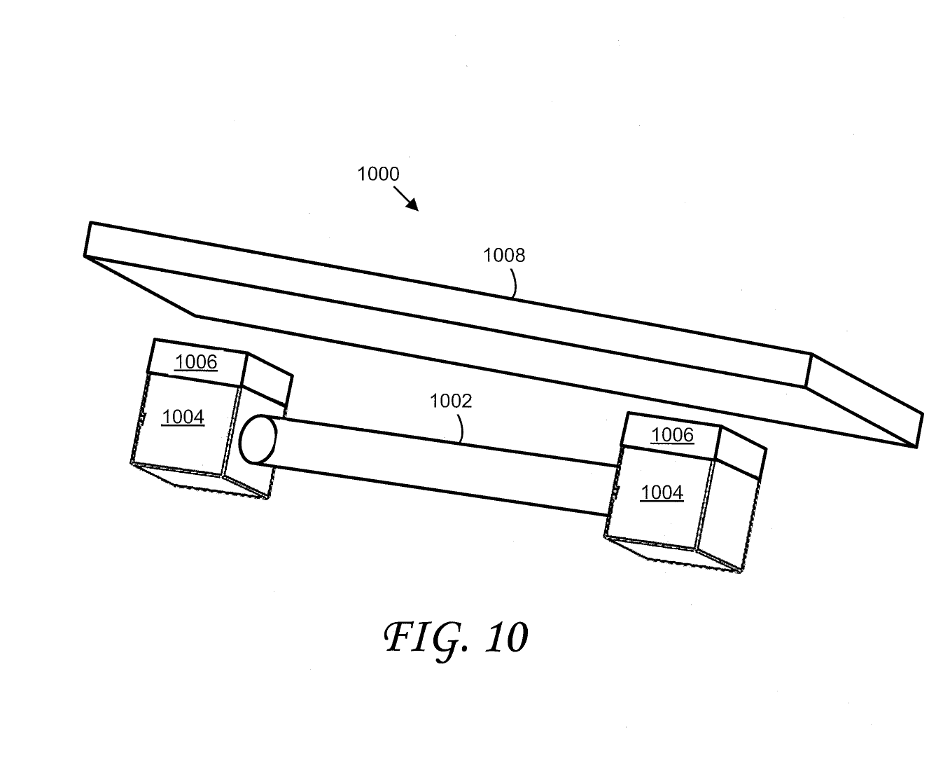

FIG. 10 is a perspective view of a completed assembly 1000 including a single lamp 1002 according to the invention. The assembly 1000 includes two housings 1004. The lamp 1002 is connected to a socket (not shown) that is positioned within one or each housing 1004. The housings 1004 are removably coupled to top plates 1006. The top plates 1006 are mounted to a structure 1008, such as a ceiling. The top plates 1006 can be mounted to the structure 1008 using mounting hardware, such as screws, for example.

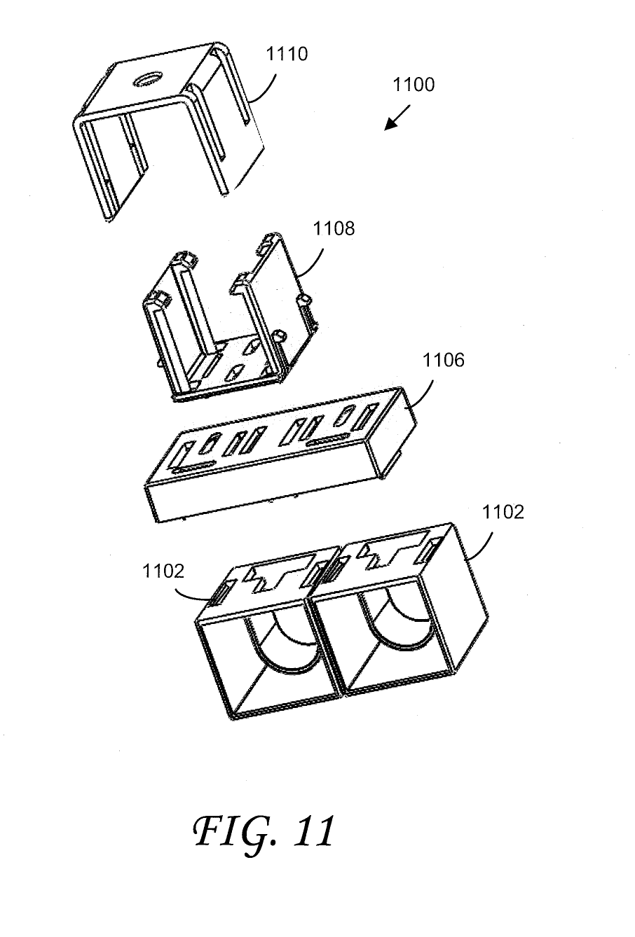

FIG. 11 is an exploded view of another assembly 1100 for supporting a pair of lamps (not shown) according to the invention. The assembly 1100 includes two housings 1102. A socket (not shown) is positioned within each housing 1102. The housings 1102 are removably coupled to a top plate 1106. When mounted to an electrical channel, the top plate 1106 can be removably coupled to an adapter 1108. A cover 1110 can be positioned over the adapter 1108 to provide additional security.

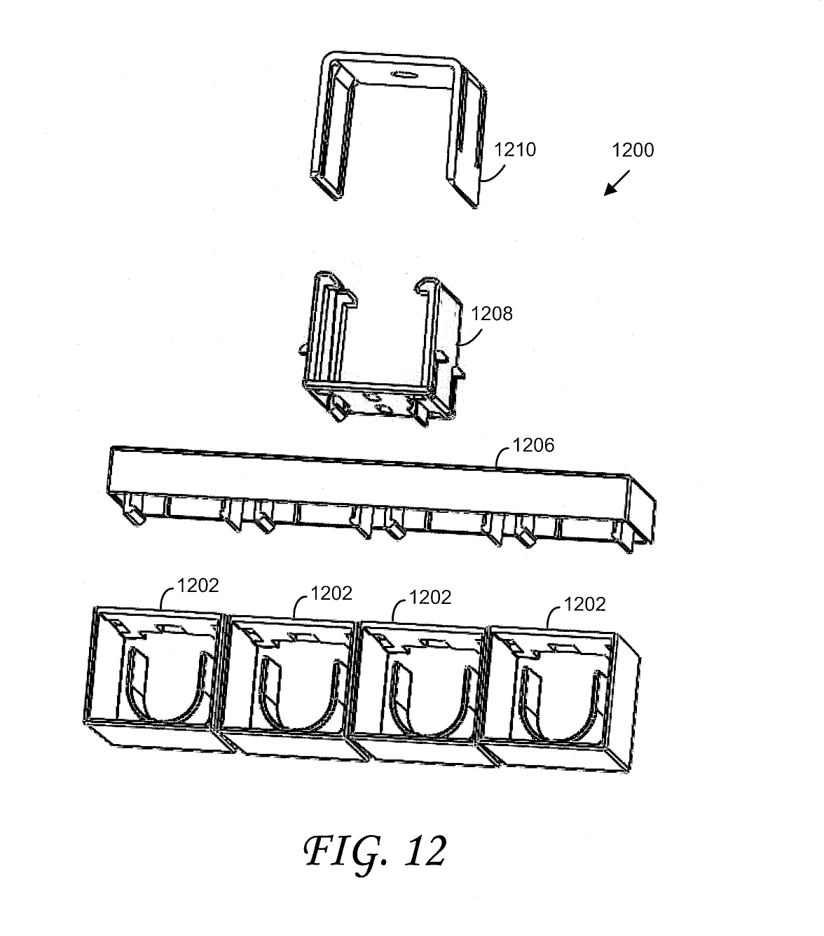

FIG. 12 is an exploded view of yet another assembly 1200 for supporting four lamps (not shown) according to the invention. The assembly 1200 includes four housings 1202. A socket (not shown) is positioned within each housing 1202. The housings 1202 are removably coupled to a top plate 1206. When mounted to an electrical channel, the top plate 1206 can be removably coupled to an adapter 1208. A cover 1210 can be positioned over the adapter 1208 to provide additional security.

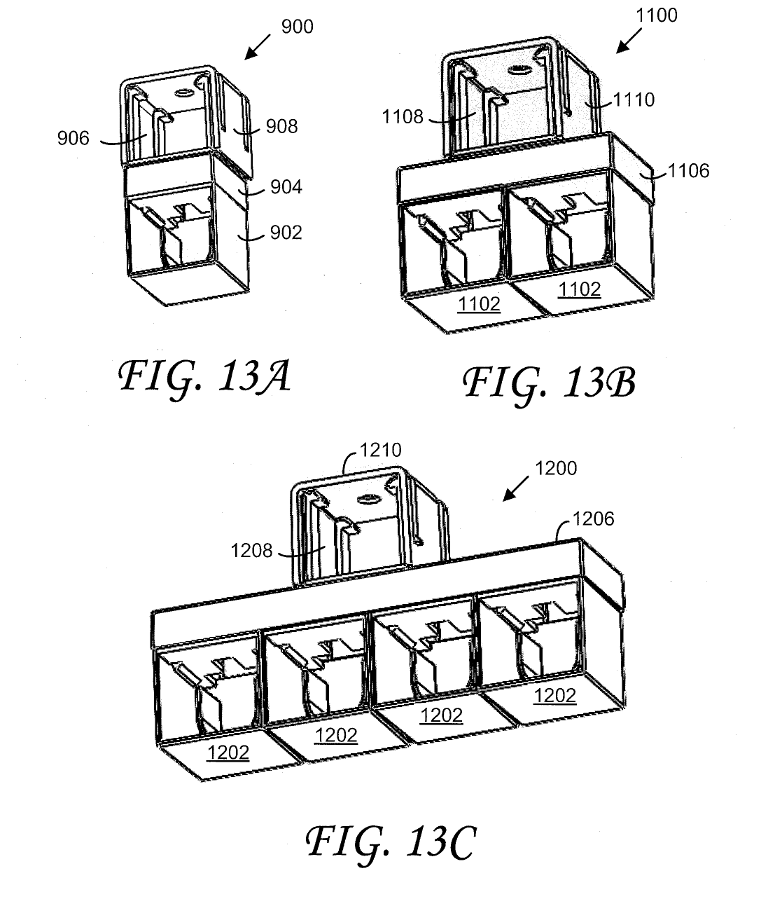

FIG. 13A illustrates the assembly 900 of FIG. 9 in an assembled state according to the invention. The assembly 900 includes the housing 902, the top plate 904, the adapter 906, and the cover 908. A socket (not shown) can be positioned within the housing 902.

FIG. 13B illustrates the assembly 1100 of FIG. 11 in an assembled state according to the invention. The assembly 1100 includes two housings 1102. The housings 1102 are removably coupled to the top plate 1106. The top plate 1106 is removably coupled to the adapter 1108. The cover 1110 is positioned over the adapter 1108 to provide additional security.

FIG. 13C illustrates the assembly 1200 of FIG. 12 in an assembled state according to the invention. The assembly 1200 includes four housings 1202. Sockets (not shown) can be positioned within each housing 1202. The housings 1202 are removably coupled to the top plate 1206. The top plate 1206 is removably coupled to the adapter 1208. The cover 1210 is positioned over the adapter 1208 to provide additional security.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

In addition, the section headings included herein are intended to facilitate a review but are not intended to limit the scope of the present invention. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item implemented structure or function;
e) any of the disclosed devices or portions thereof may be combined together or separated into further portions unless specifically stated otherwise; and
f) no specific sequence of acts or steps is intended to be required unless specifically indicated.

What is claimed is:

1. An apparatus for supporting a lamp comprising:
a top plate for mounting to a structure, the top plate including at least one protrusion;
a housing including at least one slot for accepting the at least one protrusion such that the housing and the top plate are capable of being removably coupled together; and
a socket positioned at least partially within the housing and adapted to provide electrical current to the lamp when the lamp is connected to the socket.

2. The apparatus of claim 1, wherein the lamp comprises one of a florescent lamp, light emitting diode (LED) lamp, and a halogen lamp.

3. The apparatus of claim 1, wherein the structure comprises one of an electrical channel, a ceiling and a wall.

4. The apparatus of claim 3, further comprising an adapter for mounting the top plate to the electrical channel.

5. The apparatus of claim 3, wherein the electrical channel comprises a wiremold raceway system.

6. The apparatus of claim 1, wherein an interior portion of the housing includes a U-shaped channel for supporting the socket.

7. The apparatus of claim 1, wherein the top plate is adapted to support a plurality of housings.

8. The apparatus of claim 1, wherein the top plate is mounted to the structure using at least one of a screw, a nail, a staple, glue, a latch and a hook.

9. The apparatus of claim 1, wherein the protrusion includes a latch located on a distal end.

10. The apparatus of claim 1, wherein the socket comprises one of a G13, G5, R17D, T8, T10 and T12 socket.

11. An apparatus for supporting a lamp comprising:
an adapter comprising at least a first latch for mounting the adapter to an electrical channel;
at top plate including at least a first slot for accepting the first latch such that the adapter and the top plate are capable of being removably coupled together, the top plate including at least a second protrusion;
a housing including at least one slot for accepting the second protrusion such that the housing and the top plate are capable of being removably coupled together; and
a socket positioned at least partially within the housing and adapted to provide electrical current to the lamp when the lamp is connected to the socket.

12. The apparatus of claim 11 further comprising a cover for at least partially covering the adapter.

13. The apparatus of claim 11, wherein the lamp comprises one of a florescent lamp, light emitting diode (LED) lamp, and a halogen lamp.

14. The apparatus of claim 11, wherein the electrical channel comprises a wiremold raceway system.

15. The apparatus of claim 11, wherein the socket comprises one of a G13, G5, R17D, T8, T10 and T12 socket.

16. The apparatus of claim 11, wherein an interior portion of the housing includes a U-shaped channel for supporting the socket.

17. The apparatus of claim 11, wherein the top plate is adapted to support a plurality of housings.

18. A method for installing a lamp comprising:
mounting a top plate to a structure, the top plate including at least one protrusion;
positioning a socket at least partially within a housing;
removably coupling the housing to the top plate by inserting the at least one protrusion into at least one slot in the housing; and
connecting the lamp to the socket.

19. The method of claim 18, wherein the structure comprises one of an electrical channel, a ceiling and a wall.

20. The method of claim 19 further comprising mounting the top plate to the electrical channel.
